(19) United States
(12) Patent Application Publication
(10) Pub. No.: US 2011/0088918 A1
(43) Pub. Date: Apr. 21, 2011

(54) FIRE-RATED MULTILAYER FABRIC WITH INTUMESCENT LAYER

(75) Inventor: Curtis P. Gonzales, Eagle, ID (US)

(73) Assignee: Smoke Guard, Inc., Boise, ID (US)

(21) Appl. No.: 12/907,963

(22) Filed: Oct. 19, 2010

Related U.S. Application Data
(60) Provisional application No. 61/253,059, filed on Oct. 19, 2009.

(51) Int. Cl. A62C 2/10; B32B 3/06; B23P 19/00

(52) U.S. Cl. 169/48; 428/102; 29/428

(57) ABSTRACT

The subject invention comprises a flexible multilayer fire-rated material that has at least one layer of an intumescent material. Because it is flexible, the fire-rated material is usable in situations where it is desirable for the fire-rated material to be rolled up or folded into a non-flat storage application. This allows the subject fire-rated material to be used in fire-rated and smoke-resistant barriers that are recessed in walls or ceilings until use. One end use embodiment includes without limitation, recessed or rolled up fabrics used in elevator lobby ceilings to seal off elevators or their lobbies from smoke or fire.

### CROSS-REFERENCE TO RELATED APPLICATIONS

This application claims priority to and the benefit of U.S. Provisional Patent Application No. 61/253,059, filed Oct. 19, 2009 and titled FIRE PROOF MULTILAYER FABRIC WITH INTUMESCENT LAYER, which is incorporated herein by reference in its entirety.

### TECHNICAL FIELD

The present disclosure is directed to flexible heat and vapor barriers capable of withstanding exposure to extreme heat and pressure from an impinging stream of water such as from a fire hose.

### BACKGROUND

In order to protect people in high rise buildings from smoke migrating in elevator shafts (as occurred in the infamous MGM fire in Las Vegas in 1980) high rise buildings are built with barriers in elevator lobbies which prevent smoke from moving from floor to floor. In many instances these barriers are simply doors and walls that are used to segregate an elevator lobby or an individual elevator. However, the downside of these doors and walls is that they can be unsightly and cause restrictions on architects who often prefer a more open look and feel to their buildings.

Accordingly, some architects choose to use barriers that are recessed in ceilings or walls and only become visible if there is a fire. These recessed barriers are by necessity flexible fabrics or other materials which can be rolled up into a recessed cavity when not in use. They can be rolled down to form a barrier when there is a fire or smoke event. These flexible recessed barriers are well known in the art and different configurations can be bought from companies, such as SmokeGuard Inc. of Boise, Id.

These flexible barriers are typically effective at preventing smoke migration, but some are not designed to prevent migration of an intense fire. Some flexible barriers have been found that can withstand the high temperatures of a fire, but some certification tests require that they also are able to withstand the violent blasts from a high pressure water hose that might be used by firemen. Examples of performance requirements are set forth by standardized tests such as the UNDERWRITER LABORATORIES™ 10C test (“UL 10C”) and the American Society for Testing and Materials (ASTM) E119 test (“ASTM E119), which are both incorporated herein in their entirety. There are several tests in use in different industries and different areas. These tests generally describe a time-temperature curve. Some data points on the curve that determine the character of the curve are as follows:
1000° F. (538° C.) at 5 minutes
1300° F. (704° C.) at 10 minutes
1462° F. (795° C.) at 20 minutes
1550° F. (843° C.) at 30 minutes
1638° F. (892° C.) at 45 minutes
1700° F. (927° C.) at 1 hour
1792° F. (978° C.) at 1½ hours
1850° F. (1010° C.) at 2 hours
1925° F. (1052° C.) at 3 hours
2000° F. (1093° C.) at 4 hours
   The barriers according to the present disclosure are capable of passing these tests.

Finally, it would be especially beneficial if these flexible barriers could also provide some type of improved insulation from the heat of a fire on one side so that persons on the other side of the barrier have a better chance of survival and the creation of a tenable environment can be established should egress from a building be necessitated by an egress elevator.

Accordingly, what is needed is a flexible smoke barrier that can be rolled up into a recessed space but which can also withstand intense heat, a high pressure water hose blast, thermal quenching and also have insulation properties to help minimize the heat transfer from the fire side of the barrier to the other side of the barrier.

### SUMMARY

Aspects of the new fire barrier in accordance with embodiments of the present disclosure include a layered system of textile materials, intumescent materials, and special purpose materials capable of passing standardized tests such as the UL 10C test. In some embodiments, the materials can be treated with selected chemicals, such as hydrates, to further reduce the thermal conductivity of the materials. In some embodiments, the barriers are formed of at least two segments of material, which can be seamed together using reinforced stitching to strengthen the barrier against an impinging stream of water even after the barrier has been exposed to intense heat.

Some embodiments of the present disclosure include a flexible barrier, comprising a sheet of material having a leading edge, a trailing edge attached to a spool, and two lateral edges. The sheet of material has containment loops at the lateral edges. The containment loops are configured to engage a rail in a passageway of a structure, and the sheet of material is configured to wind onto and off of the spool between an open position in which the sheet of material is wound on the spool and a closed position in which the sheet of material is at least partially unwound from the spool and blocks the passageway. The sheet of material can be made of a plurality of layers, such as an insulative layer having a first side and a second side, a first sacrificial layer on the first side of the insulative layer, and a second sacrificial layer on the second side of the insulative layer. The sacrificial layers can be consumed if the barrier is exposed to heat above a predetermined threshold.

In some embodiments, the barriers include a multi-layer, bi-directional barrier. The barriers can include a strength layer having a first side and a second side, a first phase decomposition layer on the first side of the strength layer and a second phase decomposition layer on the second side of the strength layer. The first and second phase decomposition layers can include an intumescent layer that will char when heated above a predetermined threshold temperature. The barriers can further include a first thermally reflective layer on the first phase decomposition layer and a second thermally reflective layer on the second phase decomposition layer. The first and second thermally reflective layers and the first and second phase decomposition layers can be exfoliant layers that release from the barrier when impinged by a stream of water of a predetermined volume level after the barrier is exposed to heat above a predetermined threshold.

In some embodiments, the barriers can be made according to a method including forming a base layer from a flexible, thermally insulative intumescent sheet of material having a first sacrificial layer on a first side of the base layer and a second sacrificial layer on a second side of the base layer. The first and second sacrificial layers can be thermally reflective. The method can also include attaching the barrier to a retracting mechanism into which the barrier can be retracted when not in use.

In still further embodiments, the barriers are flexible enough to be rolled and unrolled to fit within recessed smoke and fire barriers as a substitute for fire walls and fire doors. In selected embodiments, the barriers have many layers, including a base fire resistant layer made of a material such as a silica cloth. The base material can then be covered, impregnated, or sprayed with an intumescent material. Intumescent materials are materials which have fire protective properties because they expand dramatically when exposed to high heats to form a carbon based nonflammable char material. The char material also helps protect the non-exposed base material from the physical damage caused by the high pressure fire hose, in particular at seams in the base material. In some embodiments, the intumescent material is then covered by a third layer opposite the base layer. This third layer can also be made of a heat resistant or heat reflective material. Barriers according to the new technology can help protect persons and property from exposure to the heat of the fire.

### BRIEF DESCRIPTION OF THE DRAWINGS

FIG. 1 is a partially schematic view of a flexible heat and vapor barrier deployed in a passageway in a structure according to embodiments of the present disclosure.

FIG. 2 is a schematic isometric view of a flexible heat and vapor barrier material comprising an insulative layer and two thermally reflective layers according to embodiments of the present disclosure.

FIG. 3 is a schematic isometric view of a flexible heat and vapor barrier material comprising a strength layer, two insulative layers, and two sacrificial thermally reflective layers according to other embodiments of the present disclosure.

FIG. 4 is a schematic isometric view of a flexible heat and vapor barrier having several seams and containment loops according to embodiments of the present disclosure.

FIG. 5A is an enlarged cross-sectional view of a stitch for a containment loop of a flexible heat and vapor barrier according to embodiments of the present disclosure.

FIG. 5B is an enlarged cross-sectional view of a vertical seam for a flexible heat and vapor barrier according to embodiments of the present disclosure.

FIG. 5C is an enlarged cross-sectional view of a horizontal reinforcement strip for a flexible heat and vapor barrier according to embodiments of the present disclosure.

FIG. 6 is a partially schematic view of a stitch pattern for a flexible heat and vapor barrier according to embodiments of the present disclosure.

### DETAILED DESCRIPTION

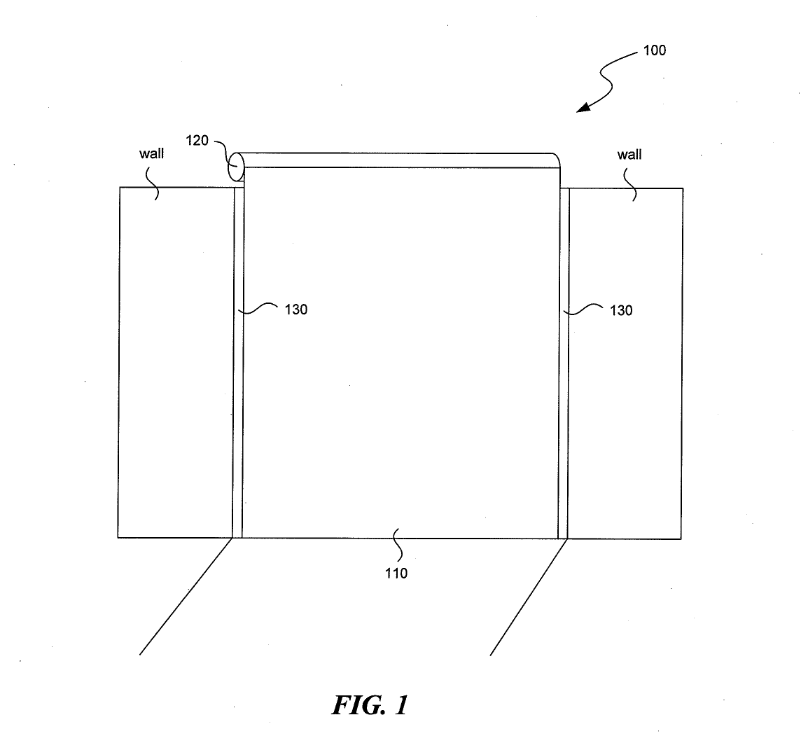

FIG. 1 illustrates a barrier system 100, including a barrier 110, a spool 120, and a set of rails 130. The barrier 110 can wind onto and off of the spool 120 as it moves between a deployed position and a retracted position. The barrier 110 can include containment loops that receive at least a portion of the rails 130, and as the barrier 110 unwinds from the spool 120, the containment loops move along the rails 130. The rails 130 can be affixed to walls 140 of a structure, such as a building or a ship. The barrier system 100 is shown in FIG. 1 having the barrier 110 suspended between the walls 140. More details of the barrier system 100 are given in patent application Ser. No. 11/828,974 filed on Jul. 26, 2007 and published on Feb. 4, 2010 as U.S. Patent Application Publication No. 2010/002499A1, which is incorporated herein by reference. The barrier system 100 is an example of a deployable barrier which can be retracted for storage when not in use. The systems and methods described herein can be applied equally for embodiments of static barriers that are not retractable.

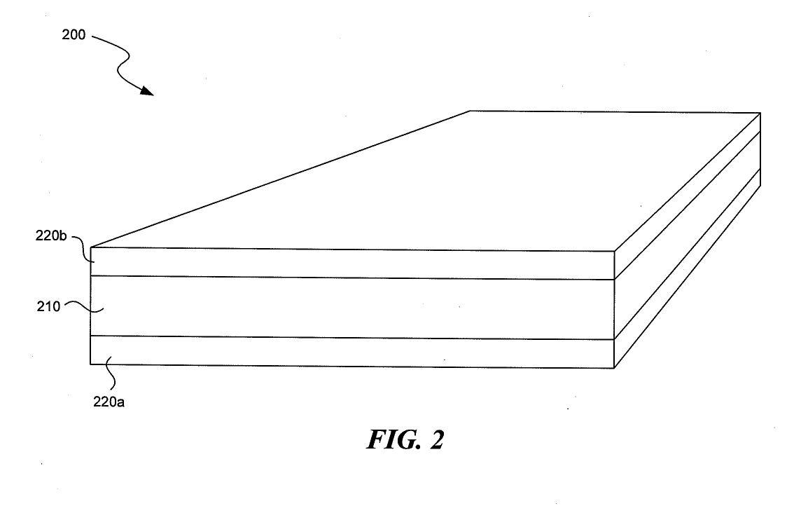

FIG. 2 illustrates an embodiment of the present disclosure including a barrier 200 made of an insulative layer 210, a first strength layer 220a and a second strength layer 220b. The insulative layer 210 is positioned between the first strength layer 220a and the second strength layer 220b. The insulative layer 210 can include intumescent materials, or it can include a base substrate that is coated, impregnated, or sprayed with intumescent materials. For example, the insulative layer 210 can be a nonwoven, fabric-like material made from long fibers, bonded together by chemical, mechanical, heat or solvent treatment. Nonwoven materials include fabrics, such as felt or rock wool, which are neither woven nor knitted, and are generally highly insulative to high temperatures. The intumescent materials can include hydrates which release moisture when heated which further reduces the thermal insulative properties of the insulative layer 210. The strength layers 220a and 220b can each be a standard refractory screen fabric, such as a silica coated silicon dioxide fabric. In some embodiments, the strength layers 220a and 220b are thermally reflective. The strength layers 220a and 220b can be coated, dipped, impregnated, or painted with a reflective material such as foil to reflect radiative heat.

The strength layers 220a and 220b can also be sacrificial layers. As the name implies, the sacrificial layers 220a and 220b may lose mechanical strength when exposed to intense heat such as produced by a fire in a structure. Suppose the first strength layer 220a is exposed to heat and the second strength layer 220b is not. The first layer 220a will initially reflect heat, but will likely yield to the heat after enough exposure. After the first layer 220a is mechanically compromised, the insulative layer 210 continues to insulate the barrier 200 for an extended period of time. While the insulative layer 210 remains, and even after the insulative layer 210 is charred by fire (and perhaps removed due to an impinging jet of water), the second strength layer 220b will withstand the heat for yet another period of time before ultimately yielding to the heat. In some embodiments, the second strength layer 220b has sufficient strength to withstand an impinging stream of water from a fire hose even after the first strength layer 220a and the insulative layer 210 are compromised by heat. The barrier 200 can therefore pass many standardized tests for fire-rated barriers, such as the UL 10C test, the ASTM E119 test, the NFPA 252 test, the UL 263 test, etc. At least one component of these tests is withstanding exposure to a predetermined heat threshold (e.g., 1700° F.) for a given period of time, and after the heat exposure, the barrier must withstand a stream of water such as a fire hose for a certain period of time (e.g., 2 minutes). The barrier 200 is sufficiently strong to pass the tests, but is much less bulky and cumbersome to operate than a steel door or other rigid barrier.

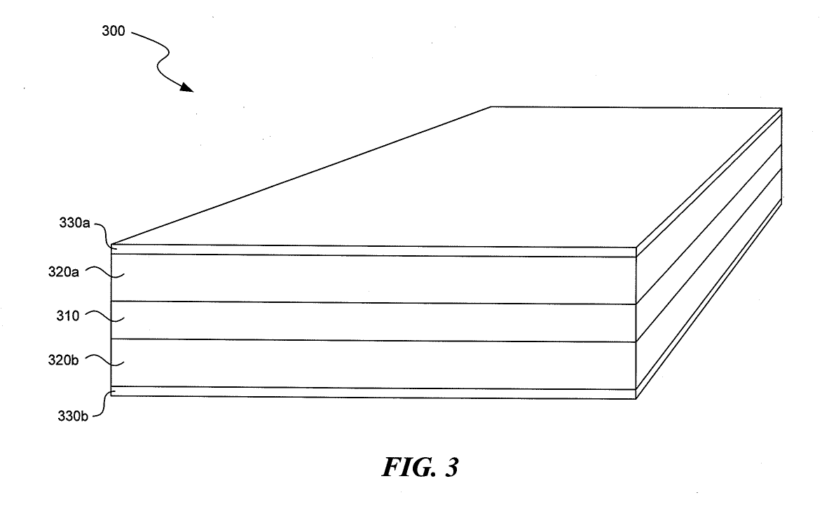

FIG. 3 illustrates a further embodiment of a barrier 300 according to the present disclosure. The barrier 300 can include a strength layer 310, and a first insulative layer 320a and a second insulative layer 320b on either side of the strength layer 310. The strength layer 310 can be made of NOMEX™, Silica Cloth, Fiber Glass, or another suitable material. In one embodiment, the strength layer 310 is made of a silica cloth (silicon dioxide 96% mass and metal oxidation 4% mass). The barrier 300 can also include a first thermally reflective layer 330a on the first insulative layer 320a, and a second thermally reflective layer 330b on the second insulative layer 320b. In some embodiments, the barrier 300 can be symmetrical about the strength layer 310, with the first insulative layer 320a and first thermally reflective layer 330a being substantially identical to the second insulative layer 320b and second thermally reflective layer 330b, respectively. The strength layer 310 can be a flexible, fabric layer made of silicon dioxide cloth. In some embodiments, the strength layer 310 is not necessarily resistant to heat, but has relatively high mechanical strength. The insulative layers 320a and 320b can be generally similar to the insulative layers 220a and 220b shown and described above with respect to FIG. 2, and can include intumescent materials and other thermally insulative materials. The thermally reflective layers 330a and 330b can be a foil coating, or a thin layer impregnated with thermally reflective particles. Other thermally reflective materials can also be used. In each of the embodiments described herein, the various layers of the barriers 200 or 300 can be held together by any of a number of different attachment methods or techniques, including adhesives, pressure melding, solvents that fuse the layers, crimping, stitching and so forth.

The barrier 300 can be symmetric, and can generally withstand exposure to heat from either side of the barrier 300. For example, if the barrier 300 is installed near an entrance to an elevator lobby with the first insulative layer 320a facing the elevators, a fire in the elevator lobby will affect the first thermally reflective layer 330a and the first insulative layer 320a before affecting other layers of the barrier 300. In many applications, it can be difficult to predict where a fire will occur, so the barrier 300 is capable of withstanding exposure to heat from either side. When exposed to heat such as from a fire, the thermal layer 330a facing the heat source will reflect as much heat away from the barrier 300 as possible but will, in time, be consumed. The first insulative layer 320a then can insulate the strength layer 310 from the heat. In some embodiments, the barrier 300 is strong enough to withstand exposure to heat of approximately 1700° F. After being exposed to the heat, the barrier 300 can be sprayed with a fire hose for approximately 2 minutes, as required by the various standards. The strength layer 310 is strong enough to withstand this pressure. There are many standardized building code tests referenced above which provide details regarding the heat exposure, and the volume, pressure, time, and direction of the water stream. The barrier 300 according to the present disclosure can pass these tests, and in addition, is flexible enough to be rolled away and stowed while not in use.

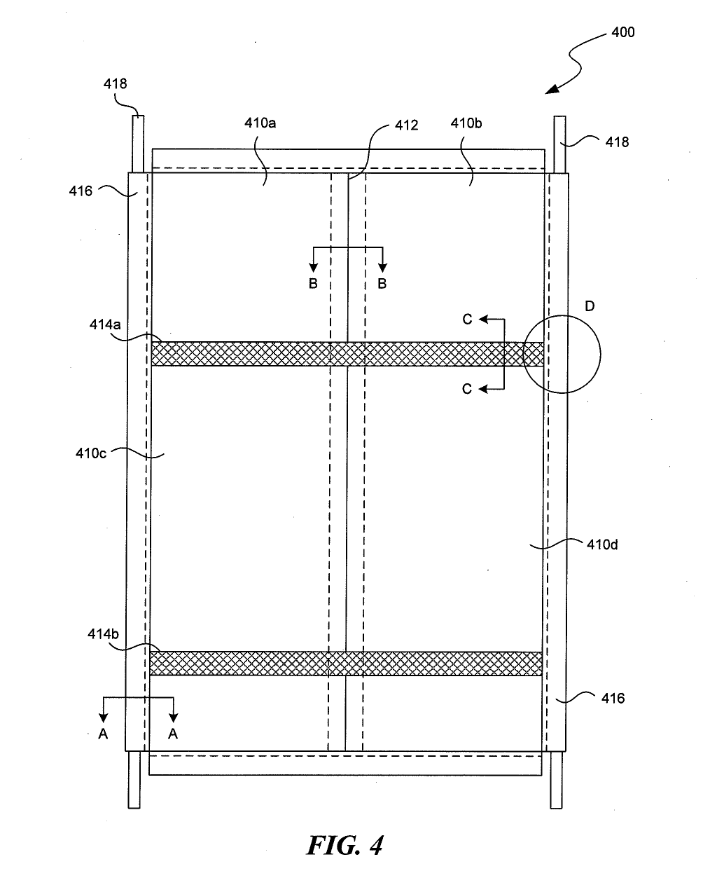

FIG. 4 depicts a barrier 400 according to an embodiment of the present disclosure in which the barrier 400 is made of several sheet segments with seams between the segments. The barrier 400 can be made of the materials described above with reference to FIGS. 2 and 3. In one embodiment, the barrier 400 includes first segments 410a and 410b joined by a vertical seam 412. The barrier 400 can also have horizontal reinforcement strips 414a and 414b between first segments 410a and 410b second segments 410c and 410d. The barrier 400 can have containment loops 416 at lateral sides of the barrier 400 that engage rails 418 to guide the barrier 400 into and out of position in a structure, generally as described above with reference to FIG. 1.

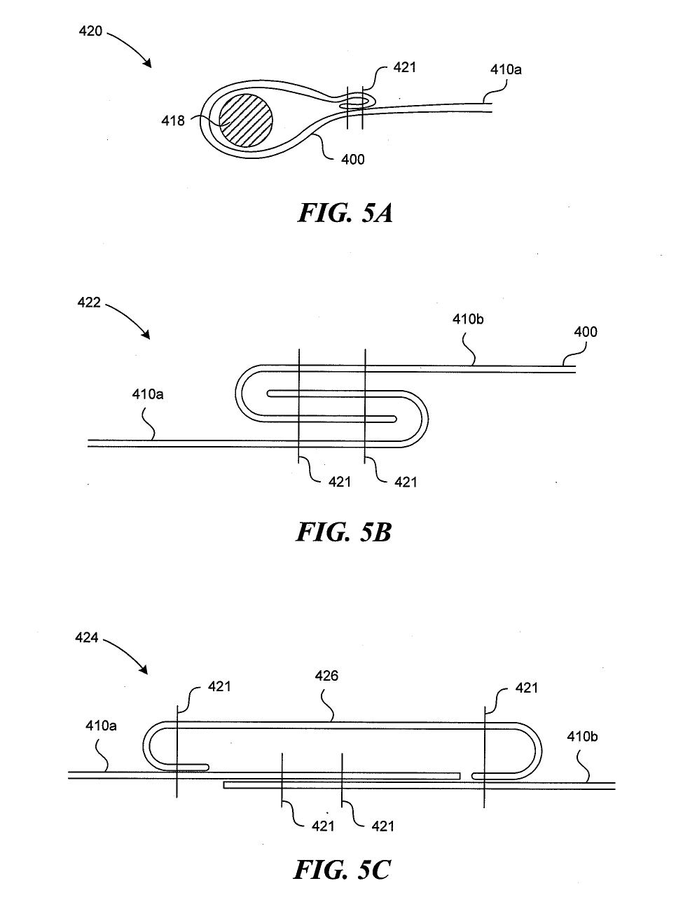

FIG. 5A illustrates a cross-sectional view of a containment loop 416 and a seam 420 shown along section A-A in FIG. 4 according to the present disclosure. The containment loop 416 can include a folded section of the barrier 400 that surrounds the rail 418, and is stitched to the barrier 400 by a stitch 421. The stitch 421 can be a reinforced French stitch in which the end of the barrier 400 is folded under, and the stitch 421 (or stitches) passes through three or more layers of the barrier material. In some embodiments, an insulating layer extends to the seam 420 but does not surround the containment loop 416.

The segment 410a of the containment loop 416 can comprise a first strength layer, a second strength layer, and an insulative layer between the first and second strength layers, similar to the embodiment described above with respect to FIG. 2. In this embodiment, the first and second strength layers are both sacrificial. After a period of exposure to heat, the strength layer facing the heat will be compromised mechanically, while the “leeward” strength layer that does not directly face the heat will maintain its mechanical strength. In this embodiment, the containment loop 416 includes a layer from each strength layer, so regardless of which side is exposed to the heat the containment loop 416 will not fail as long as the leeward strength layer maintains its strength. In some embodiments, the containment loops 416 can be recessed within a wall of a passageway to prevent direct exposure of the containment loops 416.

FIG. 5B illustrates a cross-sectional view of a vertical seam 422 along section B-B in FIG. 4 according to the present disclosure. The seam 422 can be made by folding a portion of segments 410a and 410b over one another, and then placing one or more stitches 421 through four layers of the barrier material as shown. This seam 422 shields the stitching from the most intense heat, and helps provide the mechanical strength necessary even after exposure to the heat to withstand the stream of water dictated by the standardized tests such as the UL 10C test. FIG. 5C illustrates a horizontal reinforcement strip 424 that can be used to reinforce the a seam between two segments 410a and 410b along section C-C of FIG. 4. The barrier 400 can be joined by a simply overlapping the two segments 410a and 410c (or 410 b and 410d) and placing a stitch 421 between the segments 410a and 410c. A strip of reinforcing material 426 can be placed between the segments 410a and 410b with ends folded under, in a C-shape. Stitches 421 can be placed through the reinforcing strip 426 and through the barrier 400. It is to be understood that the seams 420, 422, and the reinforcing strip 424 shown in FIGS. 5A, 5B, and 5C can be used in different portions of a single barrier 400, or different barriers can include the seams described in FIG. 5A, 5B, or 5C independently.

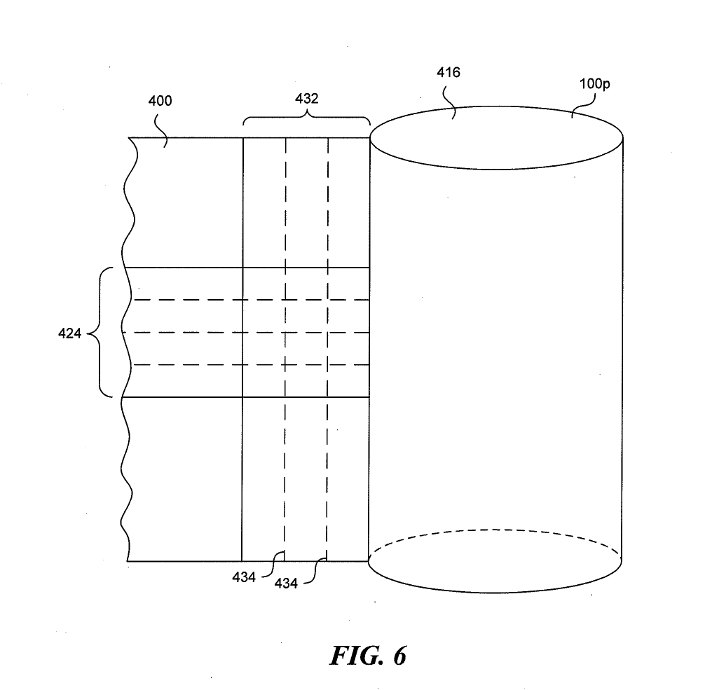

FIG. 6 illustrates another seam configuration 430 for use with a barrier 400 in accordance with the present disclosure. FIG. 6 shows an enlarged view of a section labeled D in FIG. 4. This seam configuration 430 can be used between a containment loop 416 and a horizontal seam 424, similar to those described above. At a lateral edge 432 of the barrier 400, several lines 434 of stitching can be placed in the barrier 400 to seal the containment loop 416. These lines 434 can intersect with a horizontal seam 424 similar to the seam shown in FIG. 5C, or another type of seam. Different arrangements and stitching patterns can be used, including a reinforcing strip over the stitching lines 434.

From the foregoing, it will be appreciated that specific embodiments of the invention have been described herein for purposes of illustration, but that various modifications may be made without deviating from the spirit and scope of the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally not all embodiments need necessarily exhibit such advantages to fall within the scope of the invention. Accordingly, the invention is not limited except as by the appended claims.

I/We claim:

1. A flexible fire and smoke barrier for use with a spool and a rail in a passageway of a structure, the barrier comprising:
a sheet of fire and smoke barrier material having a leading edge, a trailing edge attached to the spool, and two lateral edges, wherein the sheet of material has containment loops at the lateral edges, and wherein the containment loops are configured to engage the rail in a passageway of the structure, and further wherein the sheet of material is configured to wind onto and off of the spool between an open position in which the sheet of material is wound on the spool and a closed position in which the sheet of material is at least partially unwound from the spool and blocks the passageway;
wherein the sheet of fire and smoke material comprises a plurality of layers, comprising,
an insulative layer having a first side and a second side, and
a first sacrificial layer on the first side of the insulative layer and a second sacrificial layer on the second side of the insulative layer, wherein the first sacrificial layer is configured to be compromised if the barrier is exposed to heat above a predetermined threshold on a first side of the barrier.

2. The barrier of claim 1 wherein the first sacrificial layer directly contacts the insulative layer and the second sacrificial layer directly contacts the insulative layer, and wherein the insulative layer is configured to insulate the first sacrificial layer while the second sacrificial layer is subject to the heat and after the second sacrificial layer has been consumed by the heat.

3. The barrier of claim 2 wherein the insulative material comprises at least one of a non-woven material, a material impregnated with intumescent material, or a material with intumescent particles sprayed onto the material.

4. The barrier of claim 1 wherein the insulative layer is a first insulative layer, the barrier further comprising:
a second insulative layer, wherein the first sacrificial layer directly contacts the first insulative layer and the second sacrificial layer directly contacts the second insulative layer; and
a strength layer between the first insulative layer and the second insulative layer.

5. The barrier of claim 4 wherein at least one of the first and second sacrificial layers comprises a reflective layer configured to reflect radiative heat from the barrier.

6. The barrier of claim 4 wherein the first and second insulative layers are configured to release from the sheet of material after being exposed to the heat.

7. The barrier of claim 1 wherein the sheet of material is configured to withstand a stream of impinging water from a fire hose for approximately 2 minutes after the barrier is exposed to the heat.

8. The barrier of claim 1 wherein the sheet of material is flexible and can be wound onto and off of a spool without damaging the sheet of material.

9. The barrier of claim 1 wherein at least one of the first and second sacrificial layers contains embedded thermally reflective particles.

10. The barrier of claim 1 wherein the sheet of material is sewn together from a first segment and a second segment with a seam between the lateral edges and at least generally parallel to the lateral edges, the seam being formed between a first fold at an edge of the first segment and a second fold at an edge of the second segment, and at least one stitch passing through the first segment, the second fold, the first fold, and the second segment.

11. A multi-layer, bi-directional barrier comprising:
a strength layer having a first side and a second side;
a first phase decomposition layer on the first side of the strength layer and a second phase decomposition layer on the second side of the strength layer, wherein the first and second phase decomposition layers comprise an intumescent layer configured to char when heated above a predetermined threshold temperature; and
a first thermally reflective layer on the first phase decomposition layer and a second thermally reflective layer on the second phase decomposition layer, wherein the first and second thermally reflective layers and the first and second phase decomposition layers are configured to release from the barrier when impinged by a stream of water of a predetermined volume level after the barrier is exposed to heat above a predetermined threshold.

12. The multi-layer, bi-directional barrier of claim 11 wherein at least one of the first and second phase decomposition layers includes hydrates configured to release moisture when exposed to the heat.

13. The multi-layer, bi-directional barrier of claim 11 wherein at least one of the first and second thermally reflective layers comprise a base layer with a reflective material applied to the base layer.

14. The multi-layer, bi-directional barrier of claim 11 wherein the barrier is flexible and can be wound upon a spool without damaging the strength layer, the decomposition layers, or the thermally reflective layers.

15. The multi-layer, bi-directional barrier of claim 11 wherein the barrier is wound onto a spool that rotates to deploy the barrier in a structure, and wherein the barrier includes containment loops that slide along rails in the structure to guide the barrier into position in the structure.

16. The multi-layer, bi-directional barrier of claim 1 wherein the barrier is formed of at least two segments joined by a seam.

17. The multi-layer, bi-directional barrier of claim 16 wherein the seam is formed by interlocking U-shaped folds in the segments, with at least one stitch passing through each of the segments at least twice.

18. The multi-layer, bi-directional barrier of claim 16 wherein the seam is a reinforced seam having a C-shaped strip of material sewn over the segments where the segments meet.

19. A method of manufacturing a flexible heat and vapor barrier, comprising:
applying a first sacrificial layer on a first side of the base layer, wherein the base layer comprises a flexible, thermally insulative intumescent sheet of material;
applying a second sacrificial layer on a second side of the base layer opposite the first side of the base layer, wherein the first and second sacrificial layers are thermally reflective; and
applying the barrier to a retracting mechanism into which the barrier can be retracted when not in use.

20. The method of claim 19 wherein applying the base layer comprises applying a base layer that can withstand exposure to approximately 1700° F.

21. The method of claim 19 wherein applying the first sacrificial layer comprises applying a layer with sufficient strength to withstand an impinging stream of water after the second sacrificial layer and the base layer have been consumed by exposure to heat.

22. The method of claim 19 wherein the base layer directly contacts the first sacrificial layer and wherein the base layer is a first insulative layer, the method further comprising:
providing a second insulative layer; and
positioning a strength layer between the first insulative layer and the second insulative layer, wherein the second sacrificial layer directly contacts the second insulative layer.
